(19) United States
(12) Patent Application Publication
(10) Pub. No.: US 2026/0307820 A1
(43) Pub. Date: Oct. 8, 2026

(54) AIRCRAFT LANDING GEAR ALIGNMENT APPARATUS AND METHOD

(71) Applicant: Phase 1 Aviation LLC, Genoa, IL (US)

(72) Inventor: Zachary Martin, Genoa, IL (US)

(73) Assignee: Phase 1 Aviation LLC, Genoa, IL (US)

(21) Appl. No.: 19/088,270

(22) Filed: Mar. 24, 2025

Related U.S. Application Data
(60) Provisional application No. 63/570,584, filed on Mar. 27, 2024.

(51) Int. Cl. B64F 5/40; B25B 27/14; B64C 25/34

(52) U.S. Cl. CPC B64F 5/40; B25B 27/14; B64C 25/34

(57) ABSTRACT

An aircraft nose landing gear alignment tool, comprising a tool handle, a shaft collar extending from the tool handle, and an alignment shaft extending from the shaft collar. The alignment shaft comprising a first shaft portion having a first shaft diameter smaller than a collar diameter of the shaft collar, and a second shaft portion having a second shaft diameter smaller than the first shaft diameter. The first shaft portion extending from the shaft collar, and the second shaft portion extending from the first shaft portion. The first shaft diameter and the second shaft diameter are configured to mate with a first set of alignment apertures of the aircraft nose landing gear and a second set of alignment apertures of the aircraft nose landing gear respectively.

### CROSS-REFERENCE TO RELATED APPLICATIONS

This application is based on and claims priority to U.S. provisional Patent Application No. 63/570,584, filed on Mar. 27, 2024. This application is incorporated herein by reference in its entirety.

### FIELD

Aircraft landing gear alignment apparatus and method.

### BACKGROUND

Aircraft, particularly those with a tricycle landing gear configuration, typically include a nose landing gear assembly. This assembly is pivotal in the operation of the aircraft, especially during take-off, landing, and taxiing. The nose landing gear assembly often includes a control head and a scissor link, which are mechanically coupled to steer the wheels of the nose landing gear.

The mechanical coupling between the control head and the scissor link is often facilitated by a pin. This pin usually has a first shaft of a specific diameter that tapers into a second shaft of a smaller diameter. The first shaft is designed to fit into a first aperture of the scissor link and a first aperture of the control head, while the second shaft fits into a second aperture of the scissor link and a second aperture of the control head. When inserted, the pin aligns the first apertures together and aligns the second apertures together, thereby ensuring the correct alignment and operation of the nose landing gear assembly.

During ground handling or movement of the aircraft, the pin is often removed to disconnect the scissor link from the control head. This allows the aircraft to be moved by a ground equipment vehicle. However, before the aircraft can take off again, the pin must be reinserted into the scissor link and control head to mechanically couple them together. This reinsertion process requires precise alignment of the apertures in the scissor link and control head to ensure proper operation of the nose landing gear assembly.

Technicians and/or pilots typically perform this alignment manually, which can be a challenging and time-consuming task. Furthermore, if the alignment is not perfect, the technician and/or pilot may resort to forceful methods to overcome the breakaway force (e.g., 44.0 ft lbs) to move the control head into position, such as wrestling with electrical/hydraulic lines or light fixtures of the control head or hammering the pin into place, which could potentially damage the apertures or other components of the nose landing gear assembly.

### SUMMARY

In one aspect, the present disclosure relates to an aircraft nose landing gear alignment tool, comprising a tool handle, a shaft collar extending from the tool handle, and an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion, wherein the first shaft diameter and the second shaft diameter are configured to mate with a first set of alignment apertures of the aircraft nose landing gear and a second set of alignment apertures of the aircraft nose landing gear respectively.

In embodiments of this aspect, the disclosed aircraft nose landing gear alignment tool further comprises a tapered portion positioned between the first shaft portion and the second shaft portion.

In embodiments of this aspect, the first shaft portion comprises a first axial length configured to span the first set of alignment apertures of the aircraft nose landing gear, and the second shaft portion comprises a second axial length configured to span the second set of alignment apertures of the aircraft nose landing gear.

In embodiments of this aspect, the handle comprises a handle axial length as measured from the shaft collar to apply torque sufficient to align the first set of alignment apertures and the second set of alignment apertures of the aircraft nose landing gear.

In embodiments of this aspect, the shaft collar is positioned relative to the first shaft portion and the second shaft portion to abut the first set of alignment apertures when the first shaft portion and the second shaft are respectively mated with the first set of alignment apertures and the second set of alignment apertures of the aircraft nose landing gear.

In embodiments of this aspect, the handle comprises scallop shaped grips.

In embodiments of this aspect, the collar diameter of the shaft collar is larger than the diameter of the first set of alignment apertures.

In embodiments of this aspect, the handle is removably detached from the alignment shaft.

In embodiments of this aspect, the alignment tool has an overall length configured to fit in an aircraft storage compartment.

In embodiments of this aspect, the alignment tool is comprised of two components connectable at or near the shaft collar to meet the length restrictions of the aircraft storage compartment.

In embodiments of this aspect, a portion of the alignment shaft that contacts the aircraft is of a material or materials having an alignment shaft hardness value less than an nose landing gear hardness value of the material or materials of the inner diameters of the first set of alignment apertures and the second set of alignment apertures.

In embodiments of this aspect, the first shaft diameter and the second shaft diameter correspond to a first pin diameter and a second pin diameter of an alignment pin utilized in the aircraft nose landing gear during operation of the aircraft.

In one aspect, the present disclosure relates to a method of aligning an aircraft nose landing gear, comprising inserting an alignment tool into a first alignment aperture of an aircraft nose control head and a second alignment aperture of the aircraft nose control head, the alignment tool comprising a tool handle, a shaft collar extending from the tool handle, and an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion, wherein the first shaft diameter and the second shaft diameter are configured to mate with the first alignment aperture and the second alignment aperture respectively, applying torque to the tool handle until the control head is aligned with a scissor link of the aircraft nose landing gear so that the scissor link can slide between the inner faces of the first alignment aperture and the second alignment aperture of the aircraft nose control head.

In embodiments of this aspect, the method further comprises retracting the alignment tool from the first alignment aperture and the second alignment aperture when the control head and the scissor link are aligned.

In one aspect, the present disclosure relates to a method of aligning an aircraft nose landing gear, comprising inserting an alignment tool into a first set of alignment apertures of the aircraft nose landing gear and a second set of alignment apertures of the aircraft nose landing gear, the alignment tool comprising a tool handle, a shaft collar extending from the tool handle, and an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion, wherein the first shaft diameter and the second shaft diameter are configured to mate with the first set of alignment apertures and the second set of alignment apertures respectively, and applying torque to the tool handle until the first set of alignment apertures are aligned and the second set of alignment apertures are aligned.

In embodiments of this aspect, the method further comprises retracting the alignment tool from the first set of alignment apertures and the second set of alignment apertures.

In embodiments of this aspect, the method further comprises inserting the alignment tool into the first set of alignment apertures and the second set of alignment apertures until the shaft collar abuts the first set of alignment apertures.

In embodiments of this aspect, the first set of alignment apertures comprise a first scissor link aperture and a first control head aperture and the second set of alignment apertures comprise a second scissor link aperture and a second control head aperture.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1A is an isometric view of an aircraft, focusing on the nose landing gear where the alignment tool would be used, according to an example embodiment of the present disclosure.

FIG. 1B is an isometric view of the nose landing gear, illustrating its internal structure and assembly, according to an example embodiment of the present disclosure.

FIG. 1C is a perspective view of the aircraft nose landing gear assembly, showcasing the arrangement and relationship of its components, according to an example embodiment of the present disclosure.

FIG. 2A is an alignment view of the aircraft nose landing gear assembly, where the control head is situated above the scissor link, according to an example embodiment of the present disclosure.

FIG. 2B is an alignment view of the aircraft's nose landing gear assembly, showing the control head above the scissor link, according to an example embodiment of the present disclosure.

FIG. 3 is an orthogonal side view of an alignment tool, showing the relationship of its components, according to an example embodiment of the present disclosure.

FIG. 4A is an orthogonal view of a misaligned control head, according to an example embodiment of the present disclosure.

FIG. 4B is an orthogonal side view of the alignment tool inserted into the misaligned control head, according to an example embodiment of the present disclosure.

FIG. 4C is an orthogonal side view of the control head after the tool is used to perform rough alignment of the control head with the scissor link, according to an example embodiment of the present disclosure.

FIG. 4D is an orthogonal view of the roughly aligned control head and scissor link after the alignment tool is removed, according to an example embodiment of the present disclosure.

FIG. 4E is an orthogonal view of the scissor link inserted between the control head mounts, according to an example embodiment of the present disclosure.

FIG. 4F is an orthogonal side view of the tool inserted into the control head and scissor link apertures to perform proper alignment, according to an example embodiment of the present disclosure.

FIG. 4G is an orthogonal view of the control head properly aligned with the scissor link after the alignment tool is removed, according to an example embodiment of the present disclosure.

FIG. 5 is an orthogonal side view of a detachable alignment tool, showcasing its component parts and their interconnections, according to an example embodiment of the present disclosure.

FIG. 6 presents an orthogonal view of a flowchart for the aircraft nose landing gear alignment process, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure relates to an alignment tool designed for use with an aircraft's nose landing gear. The alignment tool is particularly useful for aligning the control head and the scissor link of the nose landing gear. The control head and the scissor link are mechanically coupled components that play a pivotal role in the steering of the aircraft's nose landing gear. The alignment tool is designed to facilitate the precise alignment of these components, which is a prerequisite for their proper mechanical coupling.

The alignment tool comprises a tool handle, a shaft collar extending from the tool handle, and an alignment shaft extending from the shaft collar. The alignment shaft includes a first shaft portion and a second shaft portion. The first shaft portion has a first shaft diameter that is smaller than the collar diameter of the shaft collar. The second shaft portion, which extends from the first shaft portion, has a second shaft diameter that is smaller than the first shaft diameter.

The first shaft diameter and the second shaft diameter of the alignment tool are configured to mate with a first set of alignment apertures and a second set of alignment apertures of the aircraft's nose landing gear, respectively. These alignment apertures are typically found in the control head and the scissor link of the nose landing gear. The alignment tool is designed to be inserted into these apertures, thereby facilitating the alignment of the control head and the scissor link.

In some cases, the alignment tool may be used to apply torque to the control head, thereby aligning the control head with the scissor link. Once the control head and the scissor link are properly aligned, the alignment tool can be removed, and a pin can be inserted into the aligned apertures to mechanically couple the control head and the scissor link. This process ensures the proper operation of the aircraft's nose landing gear.

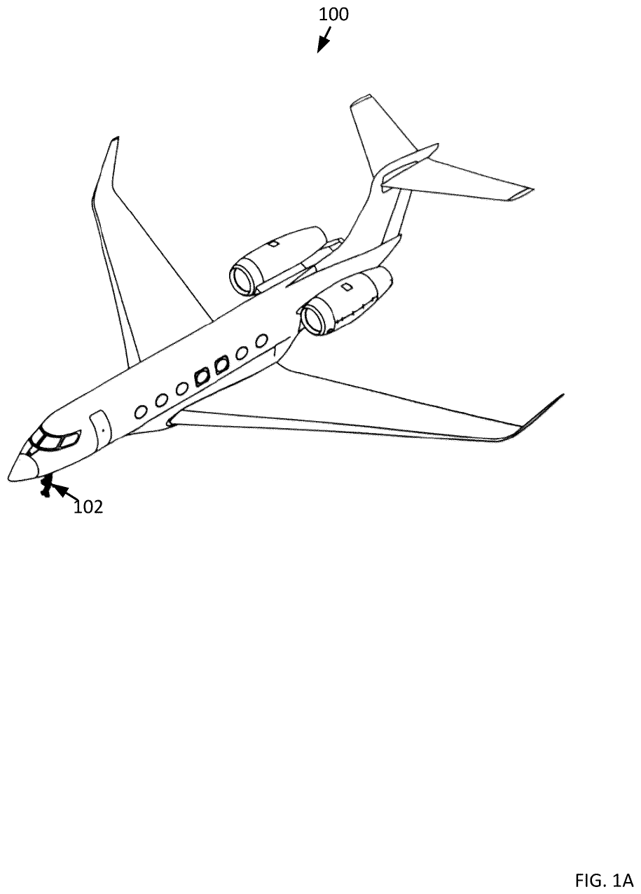

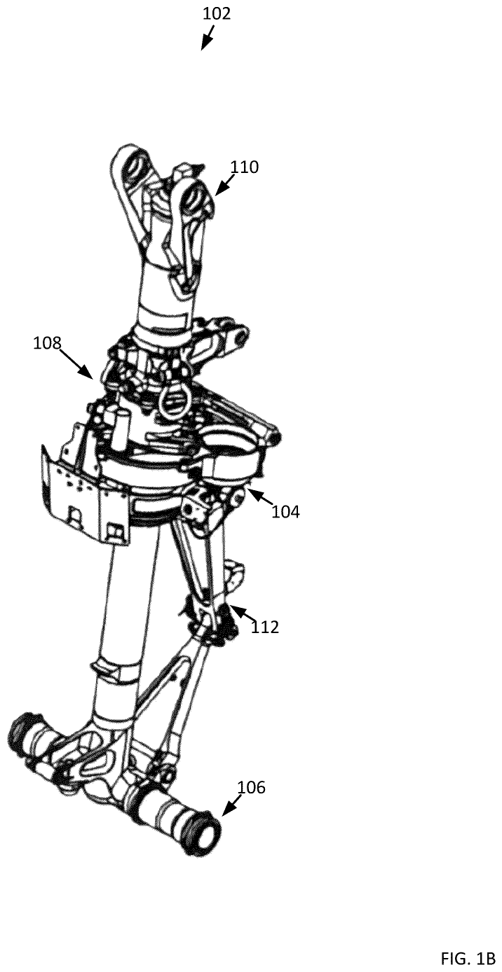

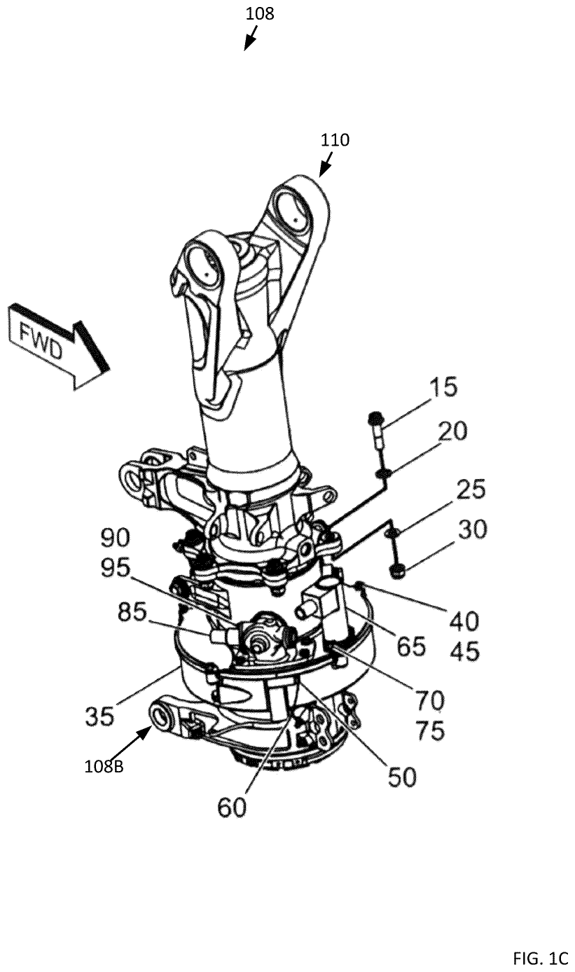

Referring to FIG. 1A, an aircraft 100 is depicted, illustrating its general external structure with a particular focus on the nose landing gear 102. The nose landing gear 102 is shown protruding from the forward lower section of the aircraft 100. This is the position where the alignment tool, as described above, would be used to ensure proper connection and alignment of the steering components within the nose landing gear assembly. The nose landing gear 102 is a pivotal component of the aircraft 100, playing an important role in the aircraft's steering, particularly during take-off, landing, and taxiing. The alignment tool is designed to facilitate the alignment of the components within the nose landing gear 102, thereby ensuring their proper operation and the overall performance of the aircraft 100.

Turning to FIG. 1B, an isometric view of the nose landing gear 102 is presented, illustrating its internal structure and assembly. The nose landing gear 102 is connected to the tire mount 106 at the base, which secures the airplane tires, and is attached via a scissor link 112 that offers support and enables movement. Above the scissor link 112, the control head lower mount 104 anchors the control head 108 to the scissor link. The control head upper mount 110 connects the control head to the airplane body (not shown), completing the assembly of the main components within the nose landing gear system.

The control head 108 and the scissor link 112 are mechanically coupled components that play an important role in the steering of the aircraft's nose landing gear. The mechanical coupling between the control head 108 and the scissor link 112 is facilitated by a pin, which is inserted into corresponding apertures in the control head 108 and the scissor link 112. In some cases, the first set of alignment apertures may comprise a first scissor link aperture and a first control head aperture, and the second set of alignment apertures may comprise a second scissor link aperture and a second control head aperture. The alignment tool and pin are designed to fit into these apertures, thereby facilitating the alignment of the control head 108 and the scissor link 112. The alignment pin has a first shaft portion and a second shaft portion. The first shaft portion has a first shaft diameter that is configured to mate with the first set of alignment apertures, which may include the first scissor link aperture and the first control head aperture. The second shaft portion, which extends from the first shaft portion, has a second shaft diameter that is configured to mate with the second set of alignment apertures, which may include the second scissor link aperture and the second control head aperture. The alignment tool or pin is designed to be inserted into these apertures, thereby facilitating the alignment of the control head 108 and the scissor link 112. These apertures and their relationship are described in more detail in later figures.

Referring to FIG. 1C, a perspective view of an aircraft nose landing gear assembly is provided, showcasing the arrangement and relationship of its components. At the top of the arrangement sits the control head 108, which includes a lower mount with two apertures, namely the control head lower mount first aperture 108A (not shown) and the control head lower mount second aperture 108B. These apertures extend from the control head 108, indicating the points where the control head mounts to the scissor link 112. The first aperture 108A and the second aperture 108B of the control head lower mount are designed to receive the pin (and therefore the alignment tool), which facilitates the mechanical coupling of the control head 108 and the scissor link 112.

It is to be understood that the arrangement and relationship of the components of the aircraft nose landing gear assembly, including the control head 108 and its apertures, may vary depending on the specific design and requirements of the aircraft. The alignment tool or pin may also be designed with different dimensions and configurations to accommodate these variations. Regardless of design, however, the control head and scissor link should be properly aligned before inserting the pin.

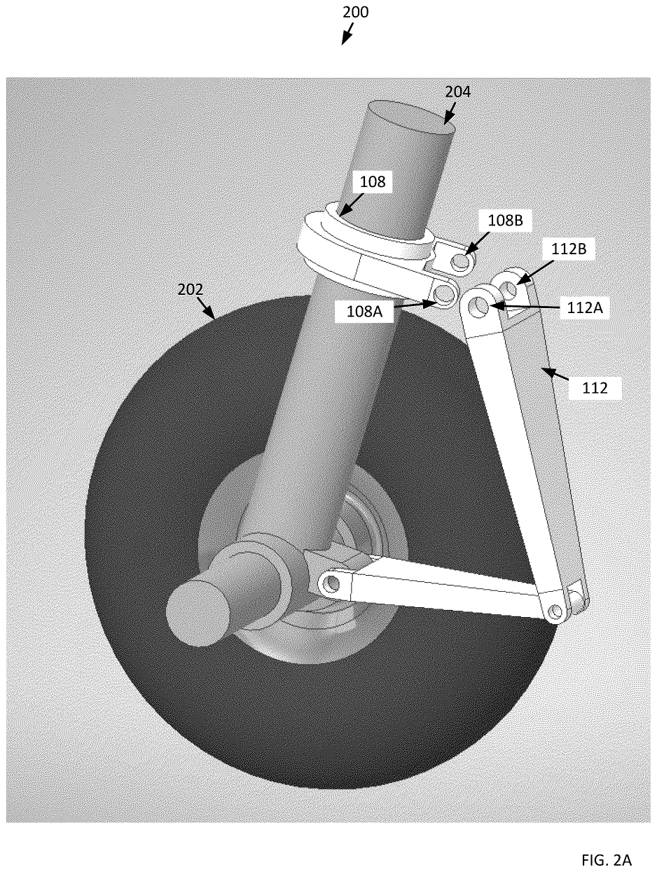

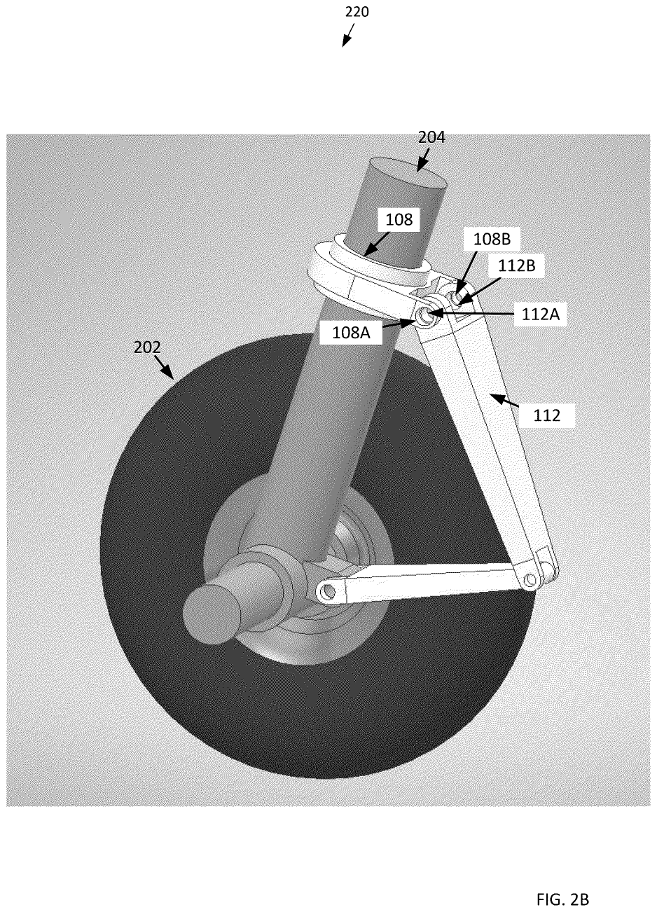

Referring to FIG. 2A, an alignment view 200 of the aircraft nose landing gear assembly including a simplified view (for sake of clarity) of tire 202 and strut/piston assembly 204 is depicted. In this view, the control head 108 is situated above the scissor link 112. In this view, the control head lower mount first aperture 108A and second aperture 108B are visible and positioned in misalignment with the corresponding scissor link first aperture 112A and second aperture 112B below. The scissor link 112 extends downward and away from the control head 108, linking the components together in the nose landing gear system.

In this misalignment view, the control head 108 and the scissor link 112 are not properly aligned, which means that the corresponding apertures in these components are not aligned either. When the apertures in the control head 108 and the scissor link 112 are not aligned, the pin cannot be properly inserted, which can prevent the mechanical coupling of these components and affect the operation of the nose landing gear.

Turning to FIG. 2B, a close-up view of an aircraft's nose landing gear alignment 220 is depicted, showing a simplified view (for sake of clarity) of tire 202 and strut/piston assembly 204, and the control head 108 positioned above the scissor link 112. In this view, the control head lower mount first aperture 108A and second aperture 108B are in proximity to and roughly aligned with the scissor link first aperture 112A and second aperture 112B. These apertures are the points of alignment for the installation of a connecting pin. Although the apertures are roughly aligned, they are not properly aligned (i.e., aligned with enough precision) to allow the pin to be easily inserted into the apertures. Conventionally, this results in the technician wrestling with the control head and/or hammering the pin until the apertures are forced into alignment. Again, such actions are dangerous to the technician and possibly damaging to the landing gear.

The alignment tool disclosed herein solves this problem. Specifically, the alignment tool has similar dimensions to the pin and is therefore designed to fit into these apertures, thereby facilitating the alignment of the control head 108 and the scissor link 112. The first shaft portion of the alignment tool, which has a first shaft diameter (similar to the pin's first shaft), is configured to mate with the first set of alignment apertures, which may include the control head lower mount first aperture 108A and the scissor link first aperture 112A. The second shaft portion of the alignment tool, which has a second shaft diameter (similar to the pin's second shaft), is configured to mate with the second set of alignment apertures, which may include the control head lower mount second aperture 108B and the scissor link second aperture 112B.

When the alignment tool is inserted into these apertures, it facilitates the proper alignment of the control head 108 and the scissor link 112. This alignment is a prerequisite for the proper mechanical coupling of these components, which is pivotal for the operation of the aircraft's nose landing gear. Once the control head 108 and the scissor link 112 are properly aligned, the alignment tool can be removed, and the pin can be easily inserted into the aligned apertures (without wrestling with the control head or hammering the pin) to mechanically couple these components safely and efficiently.

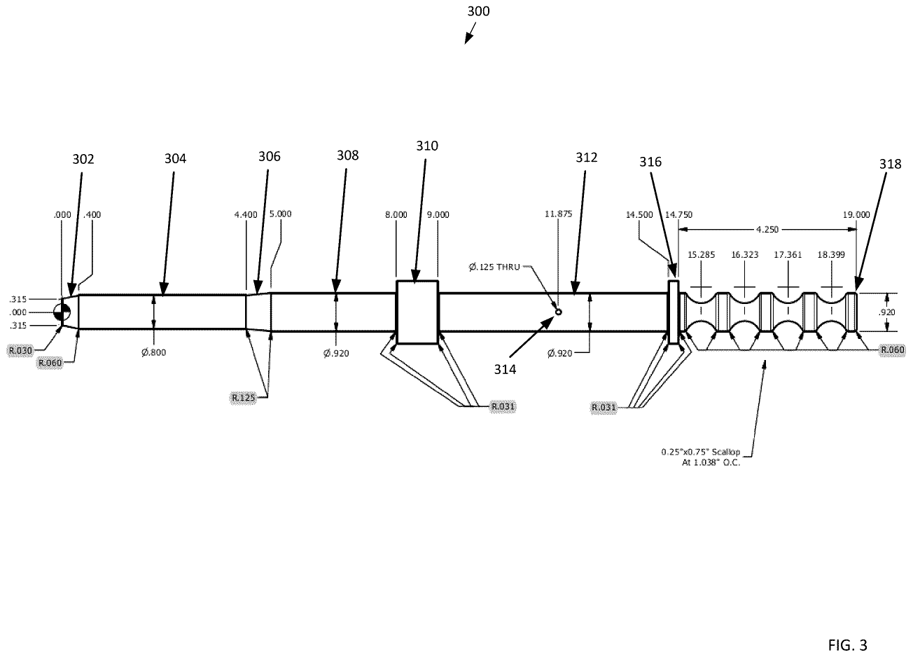

Referring to FIG. 3, an orthogonal side view of an alignment tool 300 is presented, showcasing its assembly and the relationship of its components. The alignment tool 300 generally includes a tool handle 318 with hand guard 316, a persuader shaft 312 extending from the handle a shaft collar 310, and an alignment shaft extending from the shaft collar 310. The alignment shaft comprises a first shaft portion 308 and a second shaft portion 304. The first shaft portion 308 has a first shaft diameter that is smaller than a collar diameter of the shaft collar 310. The second shaft portion 304, which extends from the first shaft portion 308, has a second shaft diameter that is smaller than the first shaft diameter 308. It is noted that the dimensions are shown in units of inches are examples of dimensions for tool 300. Other dimensions, shapes, sizes, and configurations for tool 300 are of course possible based on the dimensions of the alignment apertures of the control head and the scissor link of the nose landing gear.

In some cases, the alignment tool 300 may include a tapered portion 306 positioned between the first shaft portion 308 and the second shaft portion 304. This tapered portion 306 facilitates a smooth transition between the first shaft portion 308 and the second shaft portion 304, which can be beneficial for the insertion and removal of the alignment tool 300 from the alignment apertures of the aircraft's nose landing gear. Likewise, a tapered insertion tip 302 may also be included to help facilitate insertion of the alignment tool into the apertures.

The first shaft portion 308 and the second shaft portion 304 of the alignment tool 300 may have specific axial lengths. These axial lengths are configured to span the first set of alignment apertures and the second set of alignment apertures of the aircraft nose landing gear respectively. This configuration allows the alignment tool 300 to be properly inserted into the alignment apertures and to facilitate the alignment of the control head and the scissor link of the nose landing gear.

The tool handle 318 and persuader shaft 312 of the alignment tool 300 may have a specific axial length as measured from the shaft collar 310. This axial length is designed to provide sufficient leverage for the application of torque to the alignment tool 300. The application of torque and insertion force by the tool is beneficial for properly aligning the first set of alignment apertures and the second set of alignment apertures of the aircraft nose landing gear.

The shaft collar 310 of the alignment tool 300 is positioned relative to the first shaft portion 308 and the second shaft portion 304. This positioning allows the shaft collar 310 to abut the first set of alignment apertures when the first shaft portion 308 and the second shaft portion 304 are respectively mated with the first set of alignment apertures and the second set of alignment apertures of the aircraft nose landing gear. The collar diameter of the shaft collar 310 may be larger than the first set of alignment apertures. This configuration prevents the alignment tool 300 from being inserted too far into the alignment apertures, thereby ensuring the proper positioning of the alignment tool 300 during the alignment process. This abutment is effectively a stopping point that indicates that the alignment tool 300 is fully and properly inserted during the alignment process.

In some cases, the tool handle 318 of the alignment tool 300 may include scallop shaped grips or the like. These grips provide a comfortable and secure grip for the user, which can be beneficial for the application of torque to the alignment tool 300. Handle 318 may be made of the same material as the shafts and collars or may include a soft material grip for comfort of the technician. In general, the shafts are made of a metallic composition that is the same as, or softer than, the metallic composition of the control head and scissor link apertures. In other words, in some cases, a portion of the alignment shaft that contacts the aircraft may be of a material or materials having an alignment shaft hardness value less than a nose landing gear hardness value of the material or materials of the inner diameters of the first set of alignment apertures and the second set of alignment apertures. This configuration prevents damage to the alignment apertures during the alignment process.

The first shaft diameter and the second shaft diameter of the alignment tool 300 may correspond to a first pin diameter and a second pin diameter of an alignment pin utilized in the aircraft nose landing gear during operation of the aircraft. This correspondence ensures that the alignment tool 300 can be properly inserted into the alignment apertures and can facilitate the alignment of the control head and the scissor link of the nose landing gear. This also ensures that once the tool is removed, the pin can easily be inserted in its place.

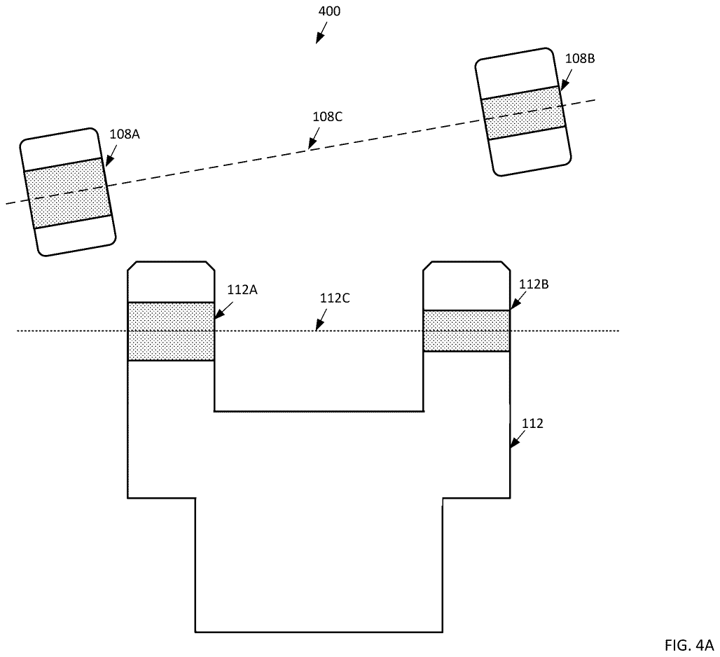

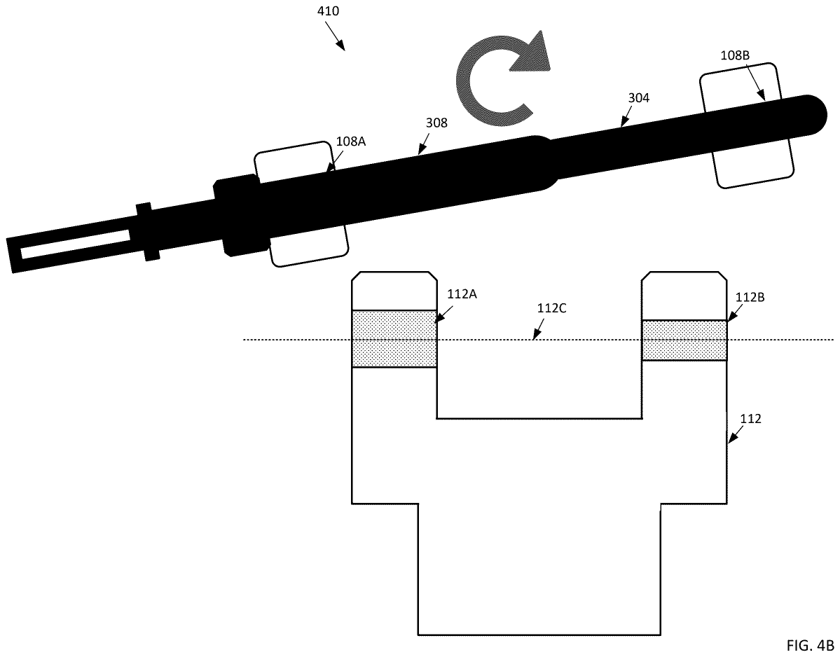

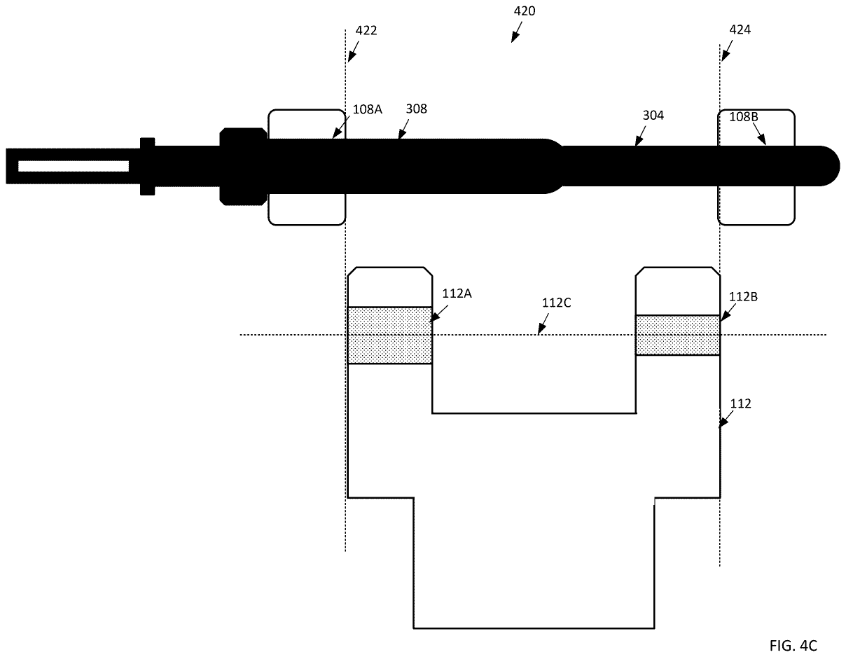

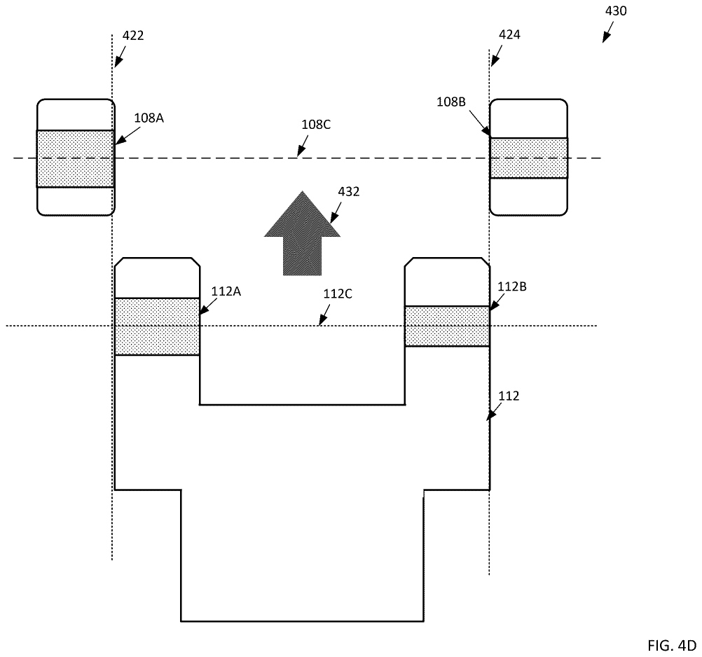

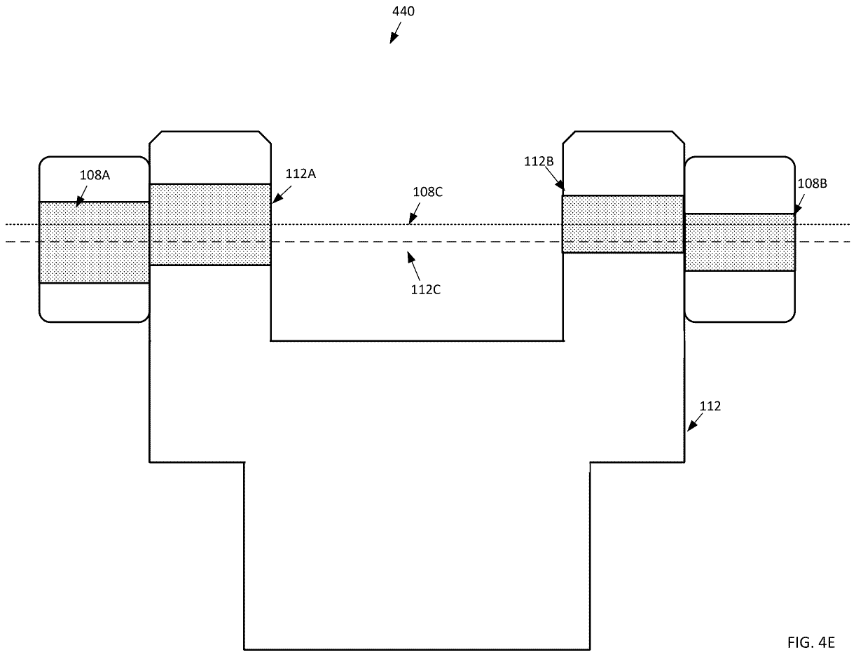

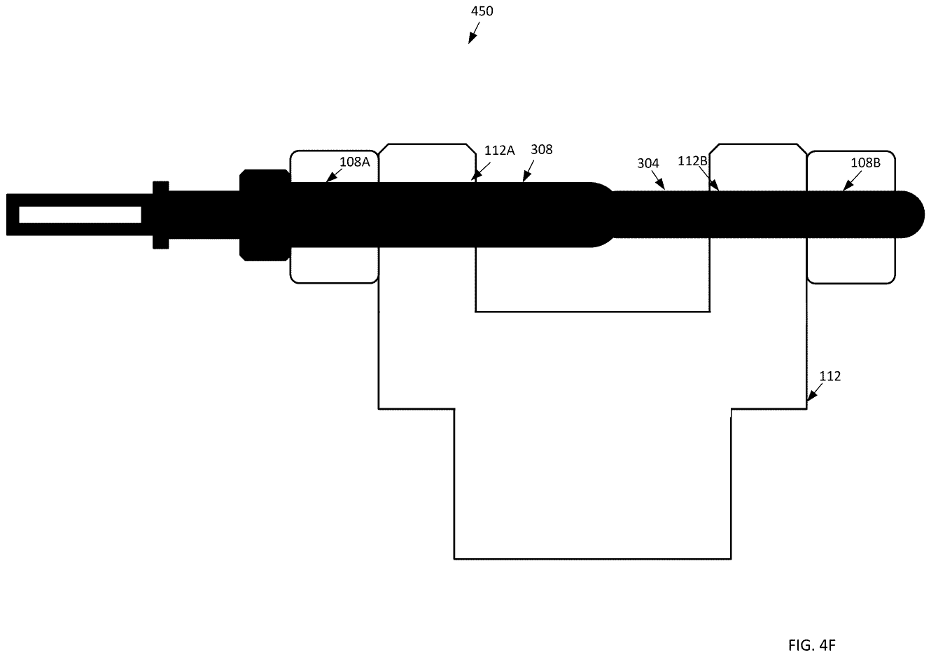

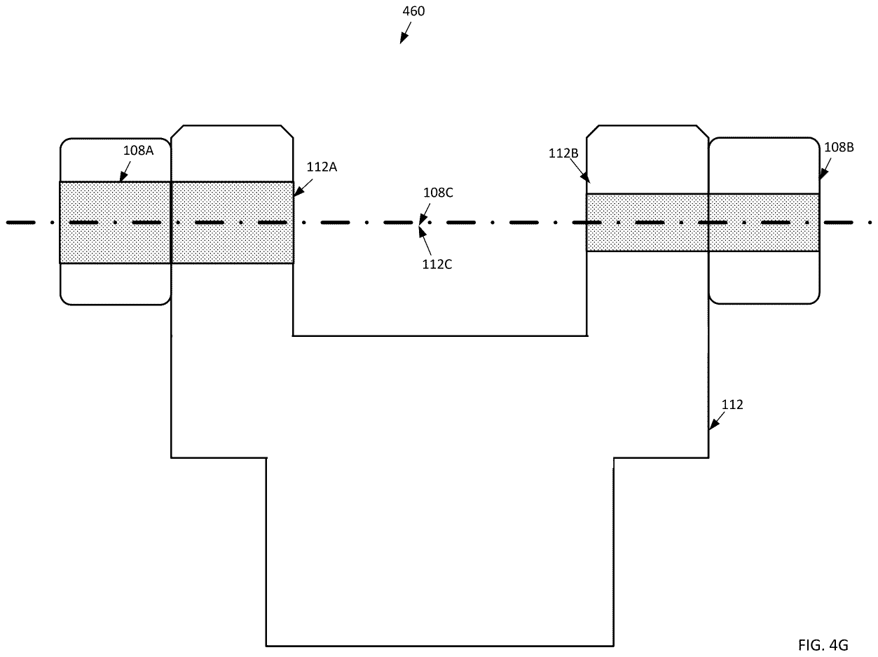

Referring to FIG. 4A, an orthogonal view of a control head alignment view 400 is presented. In this view, the control head lower mount first aperture 108A and control head lower mount second aperture 108B are projected above the scissor link first aperture 112A and scissor link second aperture 112B. These apertures are the points of alignment for the installation of a connecting pin or the alignment tool. The control head lower mount aperture alignment axis 108C and the scissor link aperture alignment axis 112C are depicted as dashed lines to indicate the intended alignment between these corresponding apertures of the control head and scissor link. In other words, in FIG. 4A, the control head and scissor link are misaligned, but when proper alignment is achieved (described below), these axes are aligned (overlapping) with one another. It is noted that control head lower mount first aperture 108A and scissor link first aperture 112A have a common first diameter, while control head lower mount second aperture 108B and scissor link second aperture 112B have a common second diameter smaller than the first diameter. The larger first diameter generally coincides with the larger first shaft portion 308 of tool 300, while the smaller second diameter generally coincides with smaller second shaft portion 304 of tool 300. Practically speaking, the first diameter is slightly larger than first shaft portion 308, while the second diameter is slightly larger than second shaft portion 304 to allow for ease of insertion of the shaft portions through apertures while still providing a snug fit for tool 300.

Referring to FIG. 4B, an orthogonal side view 410 of an aircraft nose landing gear alignment tool 300 is presented where rough alignment of the control head is performed using the alignment tool. The alignment tool 300 is inserted into the first aperture 108A and the second aperture 108B of the control head 108. Again, the alignment tool 300 features a first shaft portion 308 that is received by first aperture 108A, and a second shaft 304 that is received by second aperture 108B. This view illustrates the process of inserting the tool into the control head and applying torque to roughly align the control head 108 with the scissor link 112. Specifically, the control head may be rotated (clockwise in the figure) to roughly align with scissor link 112. In other words, the application of torque allows the technician to adjust the alignment of the control head 108 with the scissor link 112 as desired. The tool handle 318 and persuader shaft 312 are designed to provide sufficient leverage for the application of torque, facilitating the alignment process. The application of torque continues until the control head 108 is roughly aligned with the scissor link 112 such that the scissor link 112 can slide between the inner faces of the first alignment aperture 108A and the second alignment aperture 108B.

Turning to FIG. 4C, an orthogonal side view of a control head alignment view 420 is presented where rough alignment is complete. In this view, the alignment tool is still inserted in the control head lower mount first aperture 108A and second aperture 108B after the tool is used to perform rough alignment of the control head. As described above, during the alignment process, the alignment tool is inserted into the apertures of the control head until the shaft collar of the alignment tool abuts the first set of alignment apertures. This abutment ensures the proper positioning of the alignment tool during the alignment process. Once the control head is roughly aligned with the scissor link (the control head apertures and scissor link apertures are aligned along axes 422 and 424 respectively), the alignment tool can be removed.

Referring to FIG. 4D, an orthogonal view of a control head alignment view 430 is presented where the alignment tool has been removed after the rough alignment procedure. This view depicts that the control head apertures 108A/108B are aligned with scissor link apertures 112A/112B along axes 422 and 424. However, control head aperture axis 108C is still not aligned with scissor link axis 112C. To perform a rough alignment of axes 422 and 424, scissor link 112 is maneuvered by the technician along movement direction 432 such that scissor link apertures 112A/112B are positioned between control head apertures 108A/108B. The rough alignment of axes 422 and 424 is shown in FIG. 4E where scissor link apertures 112A/112B are positioned between control head apertures 108A/108B. In other words, both the control head alignment axis 108C and scissor link alignment axis 112C run through the apertures, but are slightly offset from one another, meaning that that proper alignment has not yet been achieved and it would be dangerous to the technician and aircraft to attempt to insert the pin at this point. The solution to achieving proper alignment is to first utilize the alignment tool 300 to persuade the apertures into proper alignment.

Turning to FIG. 4F, an orthogonal side view of a control head alignment view 450 is presented. In this view, the alignment tool 300 is inserted through the corresponding apertures of the aircraft nose landing gear elements that are slightly misaligned as shown in FIG. 4E. Specifically, the second shaft 304 of the alignment tool 300 is inserted and passes through the control head lower mount first aperture 108A and the scissor link first aperture 112A and eventually comes to a rest in the control head lower mount second aperture 108B and the scissor link second aperture 112B. Likewise, first shaft portion 308 is inserted and comes to a rest in the control head lower mount first aperture 108A and the scissor link first aperture 112A. Simple insertion of tool 300 may be enough to force the apertures into proper alignment. If not, the technician can apply torque to the handle of the tool until alignment is achieved. Alignment may be achieved when the technician notices that the tool is completely inserted into the aperture and the tool collar is abutting aperture 108A. In other words, the alignment tool 300 may be inserted into the first set of alignment apertures and the second set of alignment apertures until the shaft collar 310 abuts the first set of alignment apertures. This abutment ensures the proper positioning of the alignment tool 300 during the alignment process and prevents the alignment tool 300 from being inserted too far into the alignment apertures.

The alignment tool 300 may be retracted from the first alignment aperture and the second alignment aperture when the control head 108 and the scissor link 112 are aligned. This retraction allows for the removal of the alignment tool 300 once the alignment process is completed, thereby freeing up the aligned apertures for the insertion of the pin.

Referring to FIG. 4G, an orthogonal view of a control head alignment view 460 is presented after alignment with the alignment tool 300 is performed and the tool is removed. In this view, the control head lower mount first aperture 108A and control head lower mount second aperture 108B are aligned with the scissor link first aperture 112A and scissor link second aperture 112B. In other words, control head alignment aperture 108C is properly aligned with scissor link aperture 112C.

In the overall alignment process, as shown in FIGS. 4A-4G, a technician may first insert the alignment tool 300 into the apertures of the control head 108. This action allows the technician to turn the control head 108 to roughly align it with the scissor link 112. Once the control head 108 is roughly aligned with the scissor link 112, the technician may remove the alignment tool 300, insert the scissor link 112 into the control head 108, and then reinsert the alignment tool 300 into the apertures of both the control head 108 and the scissor link 112. In this configuration, the first shaft portion 308 of the alignment tool 300 aligns the first set of apertures, and the second shaft 304 aligns the second set of apertures. The alignment tool 300 is inserted and optionally torqued until the collar 310 abuts the aperture of the control head 108, ensuring the proper positioning of the alignment tool 300 during the alignment process.

As mentioned above, once the alignment of the control head 108 and the scissor link 112 is achieved, the alignment tool 300 can be removed from the apertures. This removal allows for the insertion of a pin into the aligned apertures to mechanically couple the control head 108 and the scissor link 112. The pin, which may have a first pin diameter and a second pin diameter that correspond to the first shaft diameter and the second shaft diameter of the alignment tool 300, is designed to fit into the aligned apertures, thereby facilitating the mechanical coupling of the control head 108 and the scissor link 112 for airplane operation. In other words, the tool is modeled after the pin such that the tool and pin may have the same shaft diameters corresponding to the control head and scissor link apertures.

It is to be understood that the arrangement and relationship of the components of the aircraft nose landing gear assembly, including the control head 108 and its apertures, may vary depending on the specific design and requirements of the aircraft. The alignment tool 300 and the pin may also be designed with different dimensions and configurations to accommodate these variations.

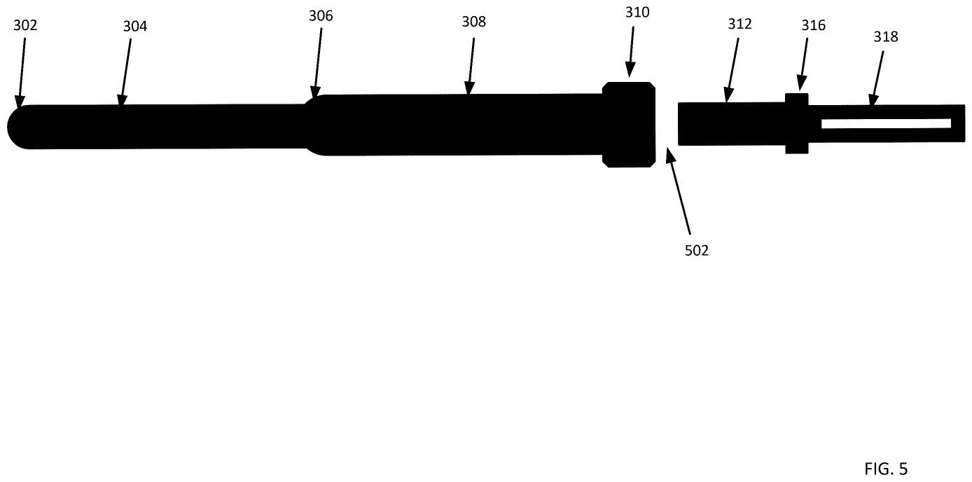

It may be desirable to store alignment tool 300 in the aircraft storage compartment. Thus, the overall size (e.g., length) of alignment tool 300 may dictated by the dimensions of the aircraft storage compartment. One solution for making storage easier is to manufacture the alignment tool 300 in multiple parts that are assembled when used and disassembled for storage. For example, referring to FIG. 5, an orthogonal side view of a detachable alignment tool 500 is presented. The alignment tool 500 is similar to the alignment tool 300, but includes a detachment point 502. This detachment point 502 allows the handle 318 to be removably detached from the alignment shaft, which includes the first shaft portion 308 and the second shaft portion 304. This detachable configuration allows the alignment tool 500 to be disassembled for storage or transport, and then reassembled for use. In some cases, the alignment tool 500 may be comprised of two components connectable at or near the shaft collar 310. This configuration allows the alignment tool 500 to meet the length restrictions of the aircraft storage compartment. It is noted that the detachment point may be in other locations of the tool and may comprise an insertable or threaded connection point between the detachable components.

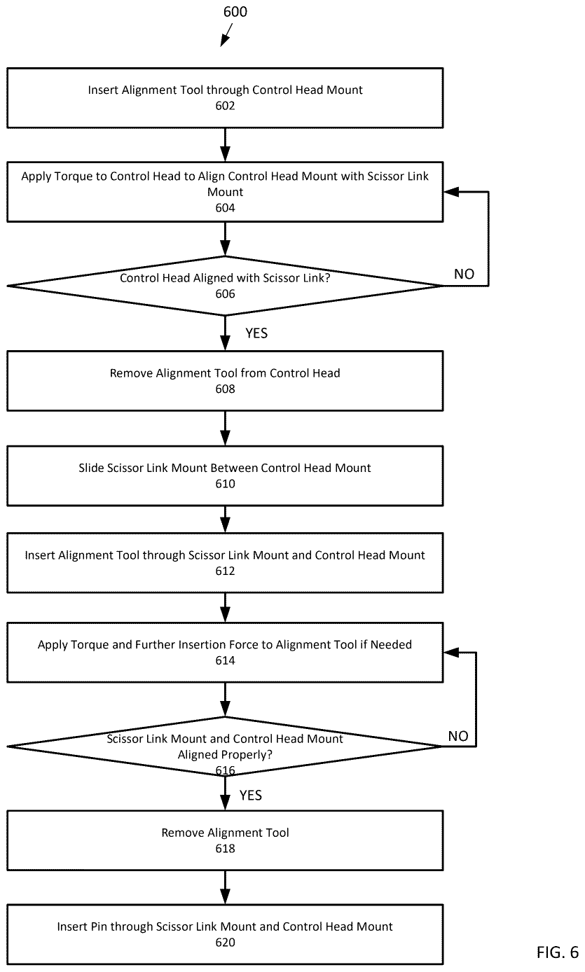

Referring to FIG. 6, an orthogonal view of an alignment flowchart 600 for an aircraft's nose landing gear process is presented. The flowchart outlines the process steps starting with inserting the alignment tool through the control head mount in step 602. This step involves inserting the alignment tool into a first alignment aperture of an aircraft nose control head and a second alignment aperture of the aircraft nose control head. In step 604, the technician applies torque to control head to align control head mount with scissor link mount. This step involves applying torque to the tool handle until the control head is aligned with a scissor link of the aircraft nose landing gear so that the scissor link can slide between the inner faces of the first alignment aperture and the second alignment aperture. Following this, the technician determines if the control head aligned with scissor link in step 606. If NO, more torque is applied. If YES, however, the technician removes the alignment tool from control head in step 608. This step generally involves retracting the alignment tool from the first alignment aperture and the second alignment aperture when the control head and the scissor link are aligned. In step 610, the technician slides the scissor link mount between control head mount. In step 612, the technician inserts the alignment tool through scissor link mount and control head mount”. This step involves inserting the alignment tool into a first set of alignment apertures of the aircraft nose landing gear and a second set of alignment apertures of the aircraft nose landing gear. As noted, the first shaft diameter and the second shaft diameter of the alignment tool are configured to mate with the first set of alignment apertures and the second set of alignment apertures respectively. If adjustments are needed, in step 614, the process may involve applying torque and further and/or repeated insertion force to alignment tool if needed. This step generally involves applying torque to the tool handle until the first set of alignment apertures are aligned and the second set of alignment apertures are aligned. At step 616, the technician determines scissor link mount and control head mount aligned properly. If NO, the technician applies more torque and insertion force. If YES, however, the technician removes alignment tool in step 618. This step involves retracting the alignment tool from the first set of alignment apertures and the second set of alignment apertures. Once alignment is complete, the technician inserts the pin through scissor link mount and control head mount in step 620. The pin may be held in place by a quick release ball detent pin, a cotter pin or the like.

It is noted that while the apertures on the left side of the landing gear are larger than the apertures on the right side of the landing gear for the tool to be inserted from left to right, the opposite configuration could be possible where the apertures on the right side of the landing gear are larger than the apertures on the left side of the landing gear for the tool to be inserted from right to left. It is also possible for the apertures to all be the same size and for the tool to have a common shaft diameter to mate with apertures having the same size.

While the foregoing is directed to example embodiments described herein, other and further example embodiments may be devised without departing from the basic scope thereof. It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. An aircraft nose landing gear alignment tool, comprising:
a tool handle;
a shaft collar extending from the tool handle; and
an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion,
wherein the first shaft diameter and the second shaft diameter are configured to mate with a first set of alignment apertures of the aircraft nose landing gear and a second set of alignment apertures of the aircraft nose landing gear respectively.

2. The aircraft nose landing gear alignment tool of claim 1, further comprising a tapered portion positioned between the first shaft portion and the second shaft portion.

3. The aircraft nose landing gear alignment tool of claim 1, wherein the first shaft portion comprises a first axial length configured to span the first set of alignment apertures of the aircraft nose landing gear, and the second shaft portion comprises a second axial length configured to span the second set of alignment apertures of the aircraft nose landing gear.

4. The aircraft nose landing gear alignment tool of claim 1, wherein the handle comprises a handle axial length as measured from the shaft collar to apply torque sufficient to align the first set of alignment apertures and the second set of alignment apertures of the aircraft nose landing gear.

5. The aircraft nose landing gear alignment tool of claim 1, wherein the shaft collar is positioned relative to the first shaft portion and the second shaft portion to abut the first set of alignment apertures when the first shaft portion and the second shaft are respectively mated with the first set of alignment apertures and the second set of alignment apertures of the aircraft nose landing gear.

6. The aircraft nose landing gear alignment tool of claim 1, wherein the handle comprises scallop shaped grips.

7. The aircraft nose landing gear alignment tool of claim 1, wherein the collar diameter of the shaft collar is larger than the diameter of the first set of alignment apertures.

8. The aircraft nose landing gear alignment tool of claim 1, wherein the handle is removably detached from the alignment shaft.

9. The aircraft nose landing gear alignment tool of claim 1, wherein the alignment tool has an overall length configured to fit in an aircraft storage compartment.

10. The aircraft nose landing gear alignment tool of claim 9, wherein the alignment tool is comprised of two components connectable at or near the shaft collar to meet the length restrictions of the aircraft storage compartment.

11. The aircraft nose landing gear alignment tool of claim 1, wherein a portion of the alignment shaft that contacts the aircraft is of a material or materials having an alignment shaft hardness value less than a nose landing gear hardness value of the material or materials of the inner diameters of the first set of alignment apertures and the second set of alignment apertures.

12. The aircraft nose landing gear alignment tool of claim 1, wherein the first shaft diameter and the second shaft diameter correspond to a first pin diameter and a second pin diameter of an alignment pin utilized in the aircraft nose landing gear during operation of the aircraft.

13. A method of aligning an aircraft nose landing gear, comprising:
inserting an alignment tool into a first alignment aperture of an aircraft nose control head and a second alignment aperture of the aircraft nose control head, the alignment tool comprising:
a tool handle,
a shaft collar extending from the tool handle, and
an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion,
wherein the first shaft diameter and the second shaft diameter are configured to mate with the first alignment aperture and the second alignment aperture respectively;
applying torque to the tool handle until the control head is aligned with a scissor link of the aircraft nose landing gear so that the scissor link can slide between the inner faces of the first alignment aperture and the second alignment aperture.

14. The method of aligning the aircraft nose landing gear according to claim 13, further comprising retracting the alignment tool from the first alignment aperture and the second alignment aperture when the control head and the scissor link are aligned.

15. A method of aligning an aircraft nose landing gear, comprising:
inserting an alignment tool into a first set of alignment apertures of the aircraft nose landing gear and a second set of alignment apertures of the aircraft nose landing gear, the alignment tool comprising:
a tool handle,
a shaft collar extending from the tool handle, and
an alignment shaft extending from the shaft collar, the alignment shaft comprising a first shaft portion having a first shaft diameter smaller than a collar diameter of the shaft collar, and a second shaft portion having a second shaft diameter smaller than the first shaft diameter, the first shaft portion extending from the shaft collar, and the second shaft portion extending from the first shaft portion,
wherein the first shaft diameter and the second shaft diameter are configured to mate with the first set of alignment apertures and the second set of alignment apertures respectively;
applying torque to the tool handle until the first set of alignment apertures are aligned and the second set of alignment apertures are aligned.

16. The method of aligning the aircraft nose landing gear according to claim 15, further comprising retracting the alignment tool from the first set of alignment apertures and the second set of alignment apertures.

17. The method of aligning the aircraft nose landing gear according to claim 15, further comprising inserting the alignment tool into the first set of alignment apertures and the second set of alignment apertures until the shaft collar abuts the first set of alignment apertures.

18. The method of aligning the aircraft nose landing gear according to claim 15, wherein the first set of alignment apertures comprise a first scissor link aperture and a first control head aperture and the second set of alignment apertures comprise a second scissor link aperture and a second control head aperture.
